(19) United States
(12) Patent Application Publication
(10) Pub. No.: US 2008/0152166 A1
(43) Pub. Date: Jun. 26, 2008

(54) Canceling signal generator, noise reduction system and noise reduction program

(75) Inventor: Tsuyoshi Shiomi, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/000,799

(22) Filed: Dec. 18, 2007

(30) Foreign Application Priority Data
Dec. 21, 2006 (JP) 2006-344301

(51) Int. Cl. H04B 1/00; G10K 11/00

(52) U.S. Cl. 381/86; 381/94.1

(57) ABSTRACT

A noise reduction system is comprised of a rotational speed data detecting unit, a parameter detecting unit that detects a characteristic parameter representing a characteristic of a noise that is superimposed on an input signal inputted into an electronic device, a correlation forming unit that forms correlation data of the characteristic parameter and the engine rotational data, and canceling signal forming unit that forms a canceling signal and an adder that adds the canceling signal to the input signal.

### CROSS REFERENCE TO RELATED APPLICATION

The present application is based on and claims priority from Japanese Patent Application 2006-344301, filed Dec. 21, 2006, the contents of which are incorporated herein by reference.

### BACKGROUND OF THE INVENTION

1. Field of the Invention

The present invention relates to a technical measure, such as a canceling signal generator, a noise reduction system and/or a program, for reducing noises that are caused by electronic devices mounted in a vehicle.

2. Description of the Related Art

Usually, an alternator mounted in a vehicle generates AC power and converts the AC power to DC power, which is supplied to various electronic devices and accessories that are also mounted in the vehicle. The DC power usually include a noise, as described in JP-Hei-9-159472-A.

Such a noise may get into the electronic systems and devices, such as a navigation system and an audio device. In order to reduce the level of such a noise, a noise reduction system has been proposed.

In the prior art noise reduction system, the differential signal of a noise signal is sent to an electronic device to cancel the noise as shown in FIG. 6. This noise reduction system is comprised of a navigation system 100, an audio device, a battery 300, positive power supply wires 310, 320, negative power supply wires 330, 340 and a speaker 400. The positive power supply wires 310, 320 respectively include impedances Z1, Z2 to connect the navigation system 100 and the audio device 200 with the positive terminal of the battery 300, and the negative power supply wires respectively include impedances Z3, Z4 to connect the navigation system 100 and the audio device 200 with the negative terminal of the battery 300. The negative terminal of the battery 300 is connected to a vehicle body to be grounded.

The navigation system 100 includes a differential amplifier 100, which is an input circuit of an audio signal of the audio device 200. The differential amplifier 110 amplifies a difference between the potential of the audio signal that includes the alternator noises and the potential of the ground that also includes the alternator noises. Therefore, only the audio signal can be amplified by an amplifier 120 and outputted by the speaker 400.

In the differential amplifier 110, a resistor R1 is connected between the output terminal of an output buffer 210 of the audio device 200 and the positive side terminal of an operational amplifier 111, and a resistor R2 is connected between the ground or negative terminal of the audio device 200 and the negative side input terminal of the operational amplifier 111. Further, a resistor R3 is connected between the positive side input terminal of the operational amplifier 111 and the ground terminal of the navigation system 100, and a resistor R4 is connected between the negative side terminal of the operational amplifier 111 and the output terminal of the same. Incidentally, the resistors R1, R2 have the same resistance and the resistors R3, R4 have the same resistance.

However, the above noise reduction system does not always effectively cancel the noise due to variations in the resistance of the resistors R1, R2, R3, R4, in gain of the amplifier 120 and/or in the output resistance of the output buffer 210.

### SUMMARY OF THE INVENTION

Therefore, an object of the invention is to provide a technical measure that can effectively reduce noises superimposed on input signals of electronic devices. The technical measure includes a canceling signal generator, a noise reduction device and a program for reducing noises that are superimposed on input signals of electronic devices.

It has been noted that noises superimposed on input signals of on-vehicle electronic devices correlate with the rotational speed of the engine or alternator.

According to a feature of the invention, a canceling signal generator includes rotational speed data detecting means for detecting engine rotational speed data representing the number of engine revolutions in a unit time, parameter detecting means for detecting a characteristic parameter representing a characteristic of a noise that is superimposed on an input signal inputted into an electronic device, correlation forming means for forming correlation data that relate the characteristic parameter to the engine rotational data, and canceling signal forming means for forming a canceling signal to be added to the input signal thereby reducing the level of the noise.

Therefore, noise reduction can be effectively carried out without regard to variations in the resistance, gain of the amplifier or the like.

The above canceling signal generator may further include means for detecting the noise at preset timings and memory means for memorizing the correlation data. Therefore, the correlation data can be renewed time to time, so that the noise can be reduced effectively even if operation circumstances changes.

In this canceling signal generator, the noise detecting means may be arranged to stop inputting the input signal to the electric device at the preset timings when it detects the noise. Therefore, the noise can be accurately detected without having special noise extracting means.

This canceling signal generator may include speed control means that controls the number of engine revolutions in a unit time at the preset timings. That is, the canceling signal can be added to the input signal at a timing when a higher level noise may be superimposed on the input signal.

According to another feature of the invention, a noise reduction system includes the above canceling signal generator, in which the noise reduction system includes adding means for adding the canceling signal to the input signal.

According to another feature of the invention, a noise reduction program for a computer includes a step of detecting engine rotational speed data representing number of engine revolutions in a unit time, a step of detecting a characteristic parameter representing a characteristic of a noise that is superimposed on an input signal inputted into an electronic device, a step of forming correlation data that relate the characteristic parameter to the engine rotational data, and a step of forming a canceling signal to be added to the input signal thereby reducing the level of the noise. The above program may further include a step of adding the canceling signal to the input signal.

According to another feature of the invention, a noise reduction program for a computer includes a step of detecting a noise that is superimposed on an input signal inputted into an electronic device at a detecting time, a step of detecting engine rotational speed data representing number of engine revolutions in a unit time at the same timing, a step of forming correlation data that relate the noise to the engine rotational data; and a step of memorizing the correlation data.

This noise reduction program may include a step of stopping the input signal inputted to the electronic device before the step of detecting noise and a step of controlling the number of engine revolutions in a unit time at the detecting timing.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a block diagram illustrating a navigation system that includes a noise reduction system according to a preferred embodiment of the invention;

FIG. 2 is a flow diagram showing a calibration process of a noise reduction program;

FIG. 3A is a graph showing how to measure a noise;

FIG. 3B is a graph showing correlation data;

FIG. 4 is a flow diagram showing a noise reduction process;

FIG. 5 is a graph showing an idea of adjusting the phase of the canceling signal; and

FIG. 6 is a circuit diagram of a prior art noise reduction system.

### DETAILED DESCRIPTION OF THE PREFERRED EMBODIMENTS

A noise reduction system according to a preferred embodiment of the present invention will be described with reference to the appended drawings.

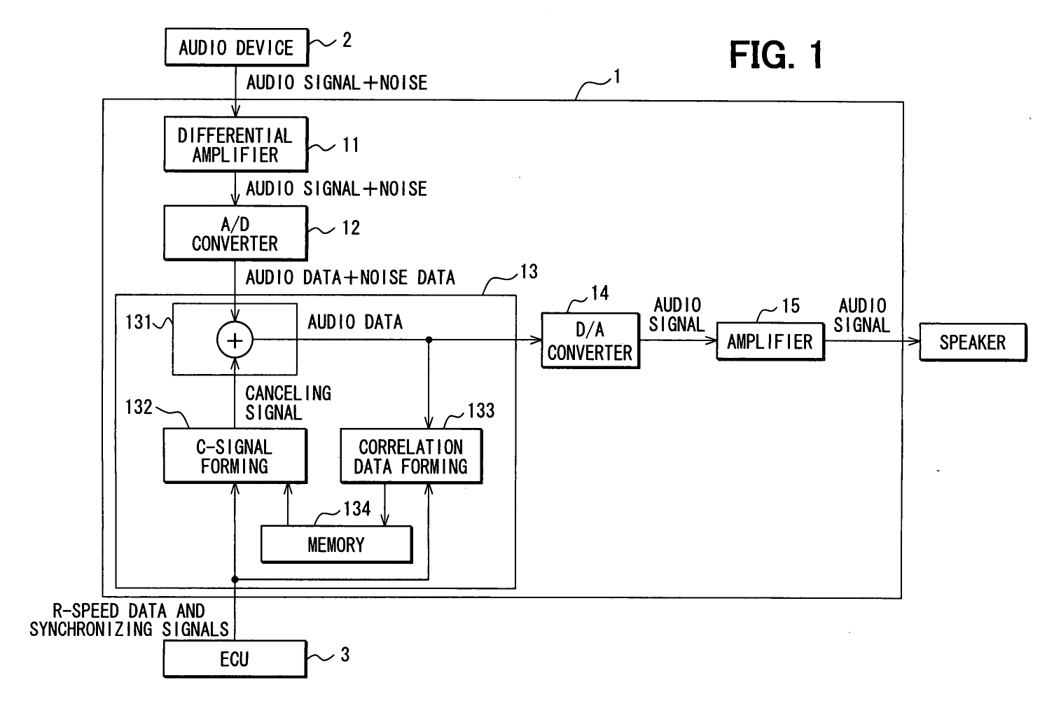

As shown in FIG. 1, a navigation system 1 for a vehicle, which is equipped with an alternator for supplying DC electric power to various electric and electronic devices or components, is connected with an audio device (e.g. a CD exchanger) 2 and an engine control unit (ECU) 3.

The navigation system 1 includes a differential amplifier 11, an A/D converter 12, a signal processing unit 13, a D/A converter 14, an amplifier 15, etc.

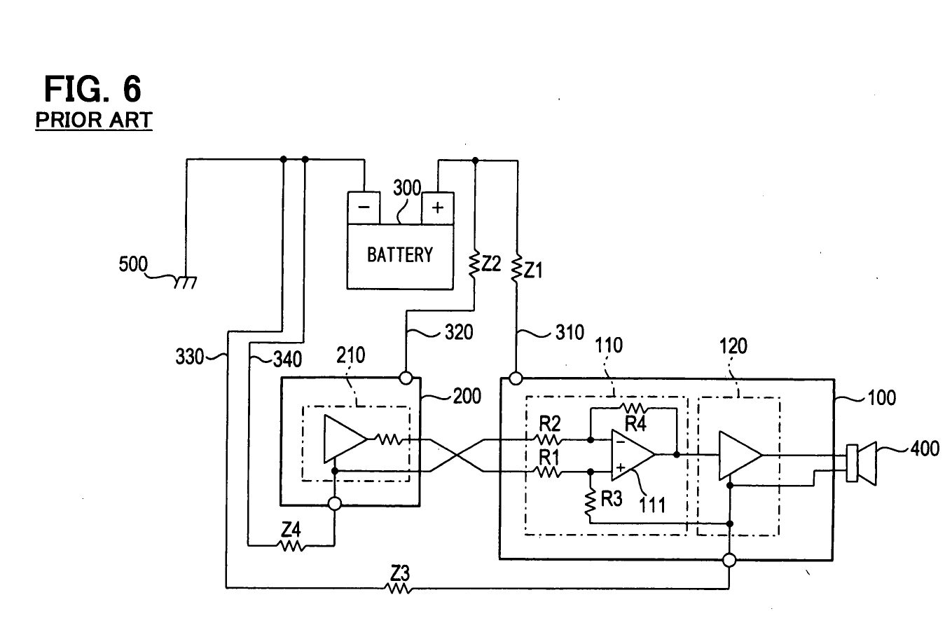

The differential amplifier 11 is a well-known type such as the differential amplifier 110 included in the noise reduction system disclosed in FIG. 6. The differential amplifier 11 reduces alternator noise superimposed on an analog audio signal inputted to the audio device and outputs the noise-reduced audio signal to the A/D converter 12. The A/D converter 12, which is a well-known type, converts the analog audio signal inputted from the differential amplifier 11 to digital audio data, which are outputted to the signal processing unit 13. Incidentally, the digital audio data still include a certain level of the alternator noises. The signal processing unit 13 removes noise data from the audio data and outputs the noise-removed audio data to the D/A converter 14. The D/A converter 14, which is a well-known type, converts the digital audio data to an analog audio signal and outputs the latter to the amplifier 15. The amplifier 15, which is a well-known type, amplifies the analog signal and outputs this signal to a speaker.

The signal processing unit 13 includes an adder 131, a canceling signal forming unit 132, a correlation data forming unit 133 and a correlation data memory 134. The adder 131 adds the digital audio data that are inputted from the A/D converter 12 to the canceling signal that is inputted from the canceling signal forming unit 132 to output as audio data.

The canceling signal forming unit 132 receives rotational speed data indicating the number of revolutions of a vehicle engine in a unit time and a synchronizing signal indicating that the rotational angle of an alternator rotor becomes a preset angle (e.g. 0° or 180°) with respect to a base angle from the ECU 3. The canceling signal forming unit 132 forms a canceling signal based on the rotational speed data, the synchronizing signal and the correlation data stored in the correlation data memory 134.

The correlation data forming unit 133 measures the audio data outputted from the adder 131 to form correlation data based on the audio data. The correlation data memory 134 stores the correlation data formed by the correlation data forming unit 133.

Incidentally, the signal processing unit 13 is a well-known type that is referred to as DSP (digital signal processor). The correlation data memory 134 is formed from a RAM. The adder 131, the canceling signal forming unit 132, the correlation data forming unit 133 jointly carry out the below-described processes according to a programs that is stored in a ROM, which is included in the signal processing unit 13.

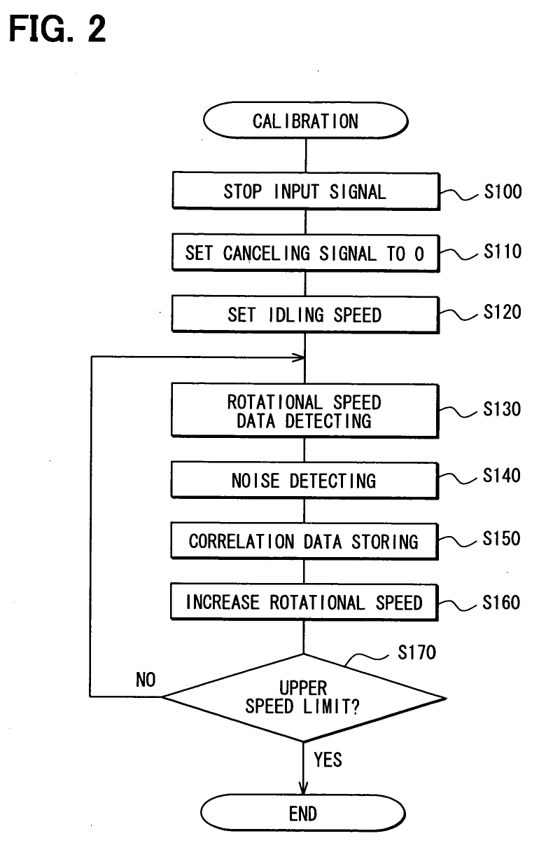

A calibration process is carried out, as shown in FIG. 2. The signal processing unit 13 carries out this process when an inspection system (not shown) for the navigation system 1 is connected thereto before shipment of a vehicle with this system on board.

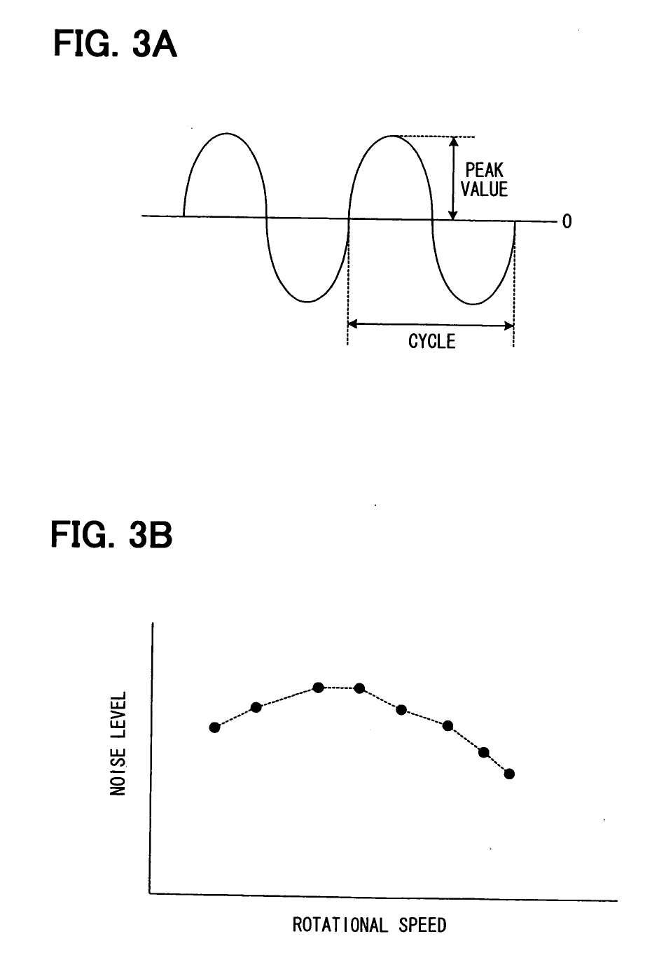

Firstly at step S100, signal inputting to the audio device 2 is stopped. Then, the level of the canceling signal is set to 0 at S110. Thereafter, the engine is controlled to run at an idling speed at S120 to obtain rotational speed data from the ECU 3 at S130. Subsequently, the audio data, which include only noise data, are measured at S140 to form correlation data that relate the result of measurement to the rotational speed data. The correlation data are stored in the correlation data memory 134 at S150. Incidentally, the peak value of the noise data and the frequency thereof are obtained at S140 by way of Fourier transform processing, as shown in FIG. 3A.

Then, a command signal to gradually increase the engine rotational speed by a preset number of revolutions to an upper limit is given to the ECU 3 at S160, and whether the engine rotational speed becomes the upper limit or not is examined at S170. If the result of the examination at S170 is NO, the step returns to S130. On the other hand, the process ends if the result of the examination at S170 is YES. Thus, the correlation data of the level of the noise and the engine rotational speed, which correspond to the frequency or cycle thereof, are formed, as shown in FIG. 3B, and stored in the correlation data memory 134.

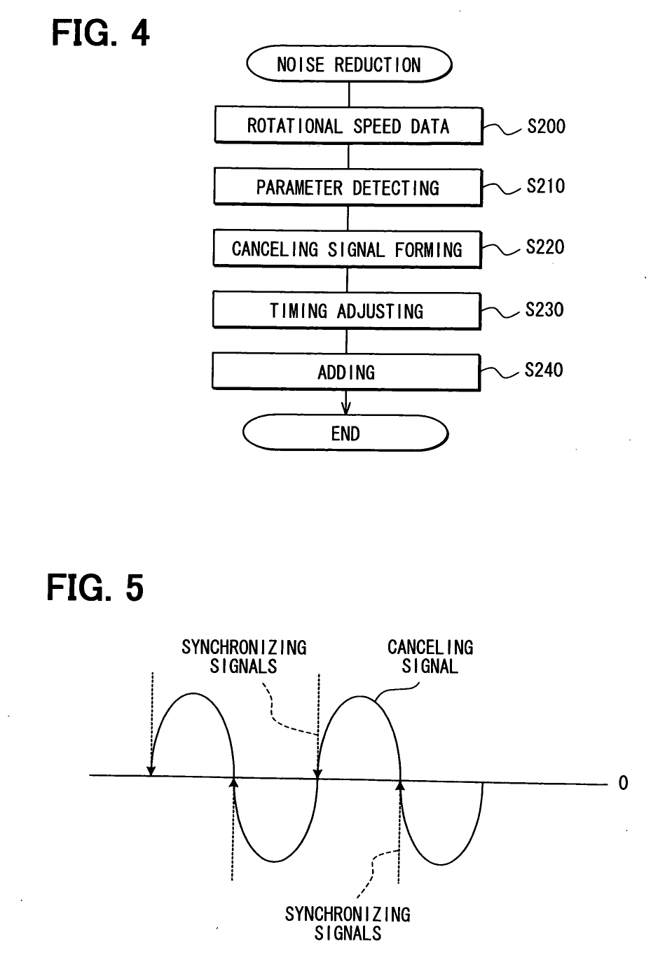

A noise reduction process is carried out as shown in FIG. 4. Incidentally, the signal processing unit 13 repeats this process as long as the navigation system 1 is turned on.

Firstly, the rotational speed data are obtained at S200. Then, the result of measurement of the peak value of the noise and the frequency thereof, which are related to the rotational speed data, is obtained from the correlation data memory 134 at S210. Subsequently, the canceling signal is formed based on the result of measurement at S220. That is, a sinusoidal wave having the same peak value of the noise and the same frequency of the noise that are related to the rotational speed data is formed, as shown in FIG. 5. Incidentally, if the level of the canceling signal is set to 0 at the step S 110 of the calibration process, the peak value is set to 0.

Then, the phase of the canceling signal is adjusted to be opposite to the phase of noise data at S230, and the audio data are added to the canceling data at S240 before the process ends. The phase of the canceling signal is adjusted by synchronizing signals, which are provided by the ECU 3, as shown in FIG. 5.

In the above embodiment, the following variations can be assumed:

(1) the step S100 of the calibration process shown in FIG. 2 may be omitted if the alternator noise is extracted from the audio signal in any other way;

(2) the differential amplifier 11 may be omitted if lower efficiency of the noise reduction can be tolerated;

(3) the correlation data memory 134 may store calculation data instead of the measured data;

(4) the peak value and the frequency of the noise data can be replaced with some other parameters that represent the alternator noise;

(5) the measured data can be stored in the correlation data memory 134 without carrying out the calibration;

(6) the signal processing unit 13, which carries out the calibration process at timings that are instructed by the inspection system for the navigation system 1, may carry out the calibration process at other timings;

(7) the engine rotational speed may be increased to a preset speed at one time at step S160; and

(8) the signal processing unit 13 may be replaced with a component other than the DSP, for example, a CPU (central processing unit), an ASIC (application specific integrated circuit) or a programmable logic device such as a field programmable gate array.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. A canceling signal generator comprising:
rotational speed data detecting means for detecting engine rotational speed data representing number of engine revolutions in a unit time;
parameter detecting means for detecting a characteristic parameter representing a characteristic of a noise that is superimposed on an input signal inputted into an electronic device;
correlation forming means for forming correlation data that relate the characteristic parameter to the engine rotational data; and
canceling signal forming means for forming a canceling signal to be added to the input signal thereby reducing the level of the noise.

2. A canceling signal generator as in claim 1 further comprising:
noise detecting means for detecting the noise at preset timings; and
memory means for memorizing the correlation data.

3. A canceling signal generator as in claim 2, wherein the noise detecting means stops inputting the input signal to the electric device at the preset timings when it detects the noise.

4. A canceling signal generator as in claim 2 further comprising speed control means for controlling the number of engine revolutions in a unit time at the preset timings.

5. A noise reduction system comprising a canceling signal generator as in claim 1, the noise reduction system comprising adding means for adding the canceling signal to the input signal.

6. An electronic device comprising a noise reduction system as in claim 5.

7. A noise reduction program for a computer comprising:
a step of detecting engine rotational speed data representing number of engine revolutions in a unit time;
a step of detecting a characteristic parameter representing a characteristic of a noise that is superimposed on an input signal inputted into an electronic device;
a step of forming correlation data that relate the characteristic parameter to the engine rotational data; and
a step of forming a canceling signal to be added to the input signal thereby reducing the level of the noise.

8. A program as in claim 7 further comprising a step of adding the canceling signal to the input signal.

9. A noise reduction program for a computer comprising:
a step of detecting a noise that is superimposed on an input signal inputted into an electronic device at a detecting time;
a step of detecting engine rotational speed data representing number of engine revolutions in a unit time at the same timing;
a step of forming correlation data that relate the noise to the engine rotational data; and
a step of memorizing the correlation data.

10. A noise reduction program as in claim 9, wherein the step of detecting a noise comprises a step of stopping the input signal inputted to the electronic device before detecting noise.

11. A noise reduction program as in claim 10 further including a step of controlling the number of engine revolutions in a unit time at the detecting timing.
